(19) United States
(12) Patent Application Publication
(10) Pub. No.: US 2008/0107406 A1
(43) Pub. Date: May 8, 2008

(54) REPRODUCTION APPARATUS AND DATA TRANSFER SYSTEM

(75) Inventor: Tomohiro Sekiguchi, Kawasaki-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 11/873,844

(22) Filed: Oct. 17, 2007

(30) Foreign Application Priority Data
Nov. 8, 2006 (JP) 2006-303381

(51) Int. Cl. H04N 7/26

(52) U.S. Cl. 386/124

(57) ABSTRACT

A reproduction apparatus which transfers data is disclosed. The reproduction apparatus includes a reproduction unit which reproduces information data stored in a storage medium, a management unit which manages pieces of information data stored in the storage medium by classifying them into a plurality of groups corresponding to types of external storage media for storing information data reproduced from the storage medium, a communication unit which communicates with an external storage apparatus that stores information data in the external storage medium, and which receives medium information relating to the type of external storage medium from the external storage apparatus, a search unit which searches the plurality of groups for a group corresponding to the type of external storage medium based on the medium information received by the communication unit, and a display control unit which displays, on a display unit, information on the group detected by the search unit.

### BACKGROUND OF THE INVENTION

1. Field of the Invention

The present invention relates to a reproduction apparatus and data transfer system.

2. Description of the Related Art

Recently, video cameras have come on the market, which incorporate large-capacity HDDs (Hard Disk Drives: to be referred to as hard disks hereinafter). The internal hard disk is often used as a storage medium for temporary video data. Video data to be saved for a long term or video data to be backed up is sometimes transferred from an internal hard disk to an external storage medium such as a DVD (Digital Versatile Disk). In general, the storage capacity of the internal hard disk is larger than that of the external storage medium.

For this reason, video data must be selected and transferred in consideration of the storage capacity of an external storage medium serving as a data transfer destination. This may increase the workload when transferring data to an external storage medium.

To solve this, Japanese Patent Laid-Open No. 2004-320349 proposes a technique of ensuring both a normal storage region (to be referred to as a hard disk region hereinafter) and a virtual disk storage region (to be referred to as a virtual disk region hereinafter) within a hard disk.

According to the technique disclosed in Japanese Patent Laid-Open No. 2004-320349, a virtual disk region can be set in correspondence with a storage medium serving as a data transfer destination when transferring video data stored in an internal hard disk to an external storage medium. The virtual disk region can reduce the workload when transferring data to an external storage medium.

However, various types of storage media such as an SD card and Blu-ray disk in addition to a DVD are available as external storage media serving as a data transfer destination. In this case, a proper virtual disk region must be selected from various types of virtual disk regions in accordance with the relationship with an external storage medium. This may cause a heavier workload when transferring data to an external storage medium.

### SUMMARY OF THE INVENTION

The present invention provides a reproduction apparatus and data transfer system capable of reducing the workload when transferring data to an external storage medium.

A reproduction apparatus according to the first aspect of the present invention comprises: a reproduction unit which reproduces information data stored in a storage medium; a management unit which manages pieces of information data stored in the storage medium by classifying the pieces of information data into a plurality of groups corresponding to types of external storage media for storing information data reproduced from the storage medium; a communication unit which communicates with an external storage apparatus that stores information data in the external storage medium, and which receives medium information relating to a type of external storage medium from the external storage apparatus; a search unit which searches the plurality of groups for a group corresponding to the type of external storage medium based on the medium information received by the communication unit; and a display control unit which displays, on a display unit, information on the group detected by the search unit.

A data transfer system according to the second aspect of the present invention comprises: a detachable external storage apparatus; a reproduction apparatus defined in claim 1; and a communication medium which connects the external storage apparatus to the reproduction apparatus.

The present invention can reduce the workload when transferring data to an external storage medium.

Further features of the present invention will become apparent from the following description of exemplary embodiments with reference to the attached drawings.

### BRIEF DESCRIPTION OF THE DRAWINGS

FIG. 1 is a view showing the configuration of a data transfer system according to the first embodiment of the present invention;

FIG. 2 is a flowchart showing the sequence of processing to capture image data by a video camcorder using a virtual medium;

FIG. 3 is a flowchart showing the sequence of processing to detect connection of a DVD external storage apparatus by the video camcorder;

FIG. 4 is a table showing a setup menu window;

FIG. 5 is a view showing all virtual medium regions contained in an internal storage medium;

FIG. 6 is a view showing a virtual medium selection window;

FIG. 7 is a view showing a virtual medium selection window;

FIG. 8 is a view showing the configuration of a data transfer system according to the second embodiment of the present invention;

FIG. 9 is a flowchart showing the sequence of processing to detect connection of a card reader/writer by a video camcorder;

FIG. 10 is a view showing all virtual medium regions contained in an internal storage medium; and

FIG. 11 is a view showing a virtual medium selection window.

### DESCRIPTION OF THE EMBODIMENTS

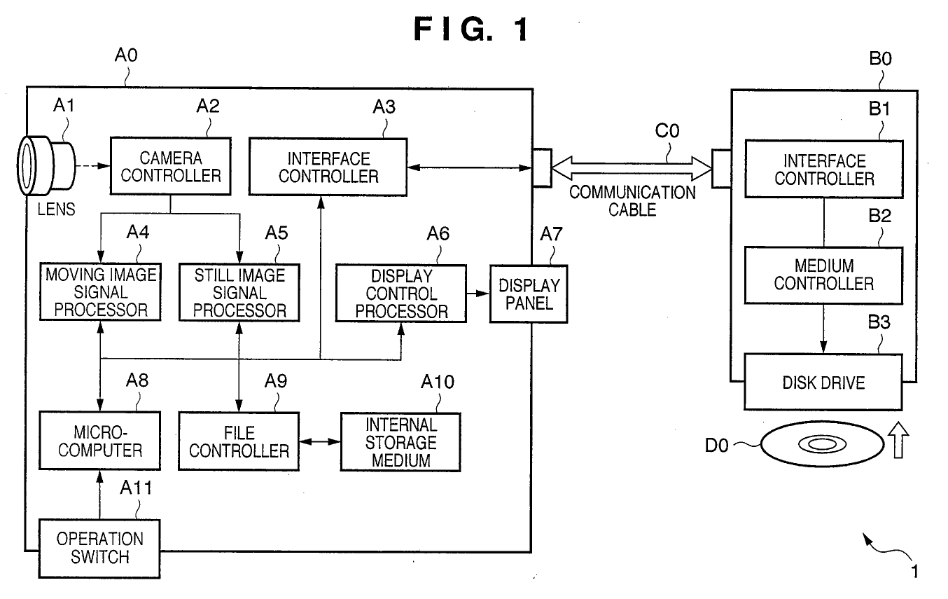

A data transfer system 1 according to the first embodiment of the present invention will be described with reference to FIG. 1. FIG. 1 is a view showing the configuration of the data transfer system 1 according to the first embodiment of the present invention.

The data transfer system 1 transfers data in order to save for a long term or to back up image data stored in an internal storage medium. The data transfer system 1 comprises a video camcorder (reproduction apparatus) A0, DVD external storage apparatus (external storage apparatus) B0, and communication cable (communication medium) C0.

The video camcorder A0 incorporates a hard disk.

The DVD external storage apparatus B0 is of an external type, and is connected to the video camcorder A0 via the communication cable C0. The DVD external storage apparatus B0 can store information (e.g., video data) received from the video camcorder A0 in an external storage medium D0. Also, the DVD external storage apparatus B0 can reproduce information stored in the external storage medium D0 to supply it to the video camcorder A0. The external storage medium D0 is, for example, a disk type high-density storage medium. The type of external storage medium D0 includes, for example, DVD-R, DVD-R-DL, and DVD-RW.

The communication cable C0 is a communication medium for connecting the video camcorder A0 to the DVD external storage apparatus B0. The communication cable C0 is, for example, a serial cable such as a USB (Universal Serial Bus) cable for serial communication.

The arrangement and operation of the video camcorder A0 will be described with reference to FIG. 1.

The video camcorder A0 comprises a lens A1, camera controller A2, moving image signal processor A4, still image signal processor A5, microcomputer (search unit and control unit) A8, operation switch (selection unit and input unit) A11, and file controller (reproduction unit, management unit, and storage unit) A9. The video camcorder A0 also comprises an internal storage medium A10, display control processor (display control unit) A6, display panel (display unit) A7, and interface controller (communication unit and output unit) A3.

The lens A1 forms the optical image of an object to the camera controller A2.

The camera controller A2 photoelectrically converts the optical image formed by the lens A1 into an electrical signal. The camera controller A2 controls the operation of the lens A1.

The moving image signal processor A4 converts an electrical signal input from the camera controller A2 into moving image data (contents) based on a photographing instruction when recording a moving image.

The still image signal processor A5 converts an electrical signal input from the camera controller A2 into still image data (contents) based on a photographing instruction when shooting a still image.

The operation switch A11 is an input interface for inputting an operation command to the microcomputer A8. For example, the operation switch A11 comprises a variety of switches for receiving a photographing request to store captured data in the internal storage medium A10, and a reproducing request to reproduce data from the internal storage medium A10. Otherwise, for example, the operation switch A11 comprises a menu switch for inputting a data transfer request to transfer data from the internal storage medium A10 to the external storage medium D0, and other switches.

The microcomputer A8 controls the overall video camcorder A0 by supplying predetermined instructions to various components of the video camcorder A0. For example, upon receiving a photographing request from the operation switch A11, the microcomputer A8 generates a photographing instruction based on the photographing request, and supplies it to the camera controller A2, moving image signal processor A4, still image signal processor A5, and file controller A9. Otherwise, for example, upon receiving a reproducing request from the operation switch A11, the microcomputer A8 generates a reproduce instruction based on the reproducing request, and supplies it to the moving image signal processor A4, still image signal processor A5, and file controller A9. Otherwise, for example, upon receiving a data transfer request from the operation switch A11, the microcomputer A8 generates a data transfer instruction based on the data transfer request, and supplies it to the file controller A9 and interface controller A3.

The internal storage medium A10 is a large-capacity storage medium incorporated in the video camcorder A0. The internal storage medium A10 is, for example, an HDD. The internal storage medium A10 includes a storage region (to be referred to as a hard disk region hereinafter) for a hard disk, and storage regions (to be referred to as virtual medium regions hereinafter) for a plurality of virtual media.

The file controller A9 controls write/read of information in/from the internal storage medium A10 based on management information. The management information is used to manage the hard disk region and virtual medium regions. For example, the management information includes identification information of the hard disk region, and information on the storage capacity of the hard disk region. For example, the management information includes identification information of each virtual medium region, and information on the type of storage medium corresponding to each virtual medium region, the storage capacity of each virtual medium region, and the recordable format of each virtual medium region. The file controller A9 also holds settable virtual medium information. The settable virtual medium information will be described in detail later.

Based on a photographing instruction, the file controller A9 stores, as a file in the internal storage medium A10, moving image data generated by the moving image signal processor A4 or still image data generated by the still image signal processor A5.

Based on a reproducing instruction, the file controller A9 reads out moving image data from the internal storage medium A10, and supplies it to the moving image signal processor A4. For example, based on a reproducing instruction, the file controller A9 reads out still image data from the internal storage medium A10, and supplies it to the still image signal processor A5.

Based on a data transfer instruction, the file controller A9 reads out moving image data from the internal storage medium A10, and supplies it to the interface controller A3. For example, based on a data transfer instruction, the file controller A9 reads out still image data from the internal storage medium A10, and supplies it to the interface controller A3.

Based on a reproducing instruction received from the microcomputer A8, the moving image signal processor A4 converts moving image data received from the file controller A9 into a display video signal. Based on a reproducing instruction received from the microcomputer A8, the still image signal processor A5 converts still image data received from the file controller A9 into a display video signal.

The display control processor A6 receives the display video signal from the moving image signal processor A4 or still image signal processor A5, and displays an image corresponding to the video signal on the display panel A7.

When the DVD external storage apparatus B0 is connected to the video camcorder A0 via the communication cable C0, the interface controller A3 transmits a detection signal to the DVD external storage apparatus B0 via the communication cable C0 to detect the external storage medium D0. As a response to the detection instruction, the interface controller A3 receives medium information from the DVD external storage apparatus B0 via the communication cable C0. The medium information includes information on the type of external storage medium D0, the storage capacity of the external storage medium D0, and the recordable format of the external storage medium D0. Based on the medium information, the interface controller A3 detects that the DVD external storage apparatus B0 has been connected via the communication cable C0, and data is storable in the external storage medium D0.

While data is storable in the external storage medium D0, the interface controller A3 supplies moving image data or still image data to the DVD external storage apparatus B0 via the communication cable C0 based on a data transfer instruction received from the microcomputer A8.

The arrangement and operation of the DVD external storage apparatus B0 will be described with reference to FIG. 1.

The DVD external storage apparatus B0 comprises an interface controller B1, medium controller B2, and disk drive B3.

When the DVD external storage apparatus B0 is connected to the video camcorder A0 via the communication cable C0, the interface controller B1 receives a detection instruction from the video camcorder A0 via the communication cable C0 to detect the external storage medium D0.

The medium controller B2 receives the detection instruction from the interface controller B1, and detects medium information on the external storage medium D0 via the disk drive B3. More specifically, the disk drive B3 determines the type of external storage medium D0, and outputs information representing the type as medium information to the medium controller B2. The medium controller B2 transfers the medium information to the interface controller B1.

The interface controller B1 transmits the medium information received from the medium controller B2 to the video camcorder A0 via the communication cable C0.

The disk drive B3 has a mounting/demounting mechanism (not shown) which allows mounting/demounting the storage medium D0.

The disk drive B3 is an interface which writes/reads out a variety of data in/from the mounted external storage medium D0.

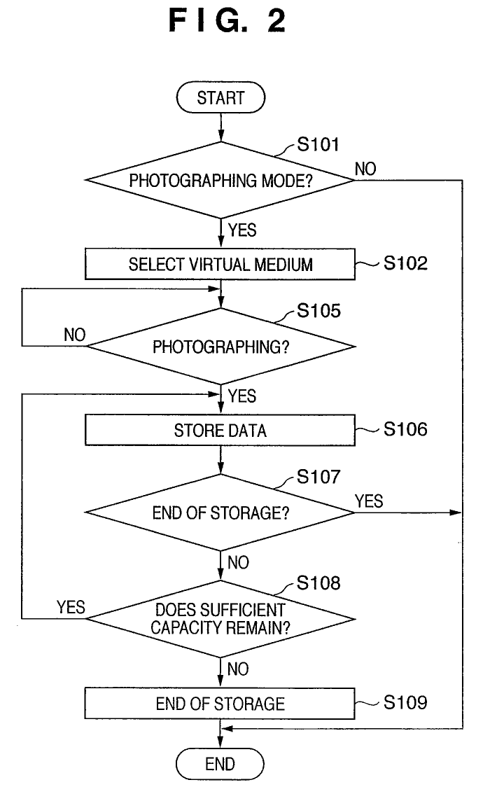

A photographing sequence by the video camcorder A0 using a virtual medium will be explained with reference to FIG. 2. FIG. 2 is a flowchart showing the sequence of processing to capture image data by the video camcorder using a virtual medium.

In step S101, the user inputs an activation request to the operation switch A11 of the video camcorder A0. The microcomputer A8 receives the activation request from the operation switch A11, and activates the video camcorder A0 based on the activation request. The microcomputer A8 determines whether the current mode is a photographing mode. If the microcomputer A8 determines that the current mode is the photographing mode, the process advances to step S102. If the microcomputer A8 determines that the current mode is not the photographing mode, the process ends.

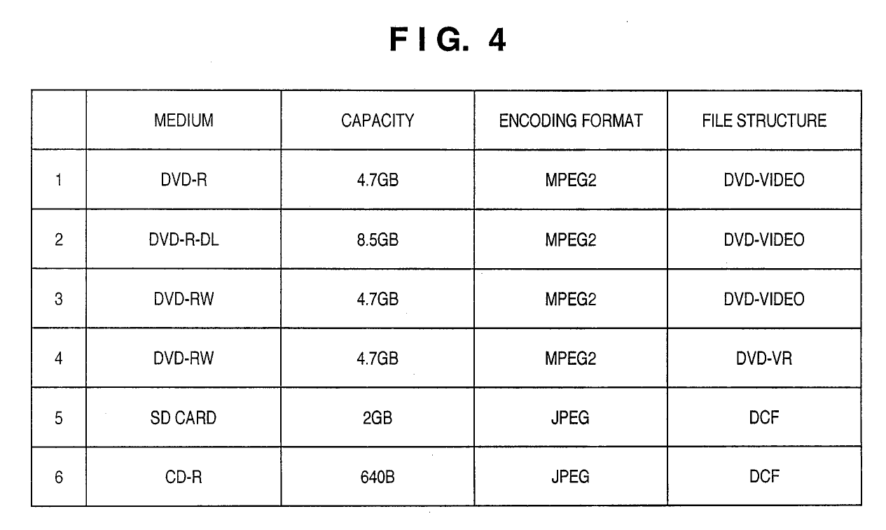

In step S102, the microcomputer A8 acquires settable virtual medium information from the file controller A9, and generates setup menu window data (see FIG. 4) based on the settable virtual medium information.

In the first embodiment, groups of each the storage capacity, the encoding format of image data, and the data structure are set in advance in accordance with storage medium types conceivable as dubbing destinations (data transfer destinations). These groups will be called virtual media.

The settable virtual medium information includes the type of virtual medium corresponding to the “medium” column, the storage capacity of the virtual medium corresponding to the “capacity” column, and the recordable format of the virtual medium corresponding to the “encoding format” and “medium” columns. The “encoding format” column represents the compression format, and the “medium” column represents the storage format of a storage medium.

The display control processor A6 receives the setup menu window data from the microcomputer A8, and displays the setup menu window on the display panel A7. For example, as shown in FIG. 4, the setup menu window displays selectable virtual medium list information. The operation switch A11 accepts a selection instruction from the user, and supplies the selection instruction to the microcomputer A8 to select a virtual medium for storing data. For example, the operation switch A11 receives an instruction to select “1” in FIG. 4 as a virtual medium. The microcomputer A8 receives the selection instruction and transfers it to the file controller A9.

Based on the selection instruction, the file controller A9 newly creates a virtual medium region within the storage region of the internal storage medium A10. For example, based on an instruction to select “1” shown in FIG. 4, the file controller A9 generates a virtual medium region which is compliant with “DVD-R”, “MPEG2”, and “DVD-VIDEO” and has a storage capacity of 4.7 GB. That is, the file controller A9 generates a logical partition corresponding to the virtual medium within the storage region of the internal storage medium A10, and updates management information by reflecting the created virtual medium region. In this manner, the file controller A9 manages pieces of information data stored in the internal storage medium A10 by classifying them into a plurality of groups (plurality of virtual medium regions) each corresponding to the type of external storage medium D0 for storing information data reproduced from the internal storage medium A10.

In step S105, the microcomputer A8 determines whether the user has designated photographing. If the microcomputer A8 has received a photographing instruction from the operation switch A11, it determines that the user has designated photographing, and the process advances to step S106. If the microcomputer A8 has not received a photographing instruction from the operation switch A11, it determines that the user has not designated photographing, and the process advances to step S105.

In step S106, the camera controller A2 photoelectrically converts an optical image formed by the lens A1 into an electrical signal, and supplies the electrical signal to the moving image signal processor A4 or still image signal processor A5.

Based on a photographing instruction, the moving image signal processor A4 encodes an electrical signal input from the camera controller A2 in the MPEG2 format, and converts it into moving image data when the user records a moving image.

Based on a photographing instruction, the still image signal processor A5 converts an electrical signal input from the camera controller A2 into still image data when the user shoots a still image.

Based on a photographing instruction, the file controller A9 stores, as a file in the internal storage medium A10, moving image data generated by the moving image signal processor A4 or still image data generated by the still image signal processor A5. At this time, the file controller A9 stores the moving image data or still image data in the virtual medium region selected and generated in step S102. Also, the file controller A9 updates the management information by reflecting the stored data.

After the end of storage, the file controller A9 supplies information representing the end of storage to the microcomputer A8.

In step S107, the microcomputer A8 determines whether storage in the internal storage medium A10 has ended. If the microcomputer A8 has received information representing the end of storage from the file controller A9, it determines that the storage has ended, and the process ends. If the microcomputer A8 has not received information representing the end of storage from the file controller A9, it determines that the storage has not ended, and the process advances to step S108.

In step S108, the microcomputer A8 transfers information to the file controller A9 to inquire whether the storage region of the internal storage medium A10 has sufficient capacity. Based on the inquiry information, the file controller A9 checks the remaining capacity of the storage region of the internal storage medium A10 by referring to the management information or accessing the internal storage medium A10. The file controller A9 transfers, to the microcomputer A8, information on the remaining capacity of the storage region of the internal storage medium A10. Based on the remaining capacity information, the microcomputer A8 determines whether the storage region of the internal storage medium A10 has a sufficient capacity. If the microcomputer A8 determines that a sufficient capacity remains, the process advances to step S106. If the microcomputer A8 determines that no sufficient capacity remains, the process advances to step S109.

In step S109, the microcomputer A8 closes each file so that all files fall within the virtual medium storage region (e.g., 4.7 GB). This allows utilizing a file within the capacity of the memory even when the size of captured data exceeds the storage capacity of the virtual medium.

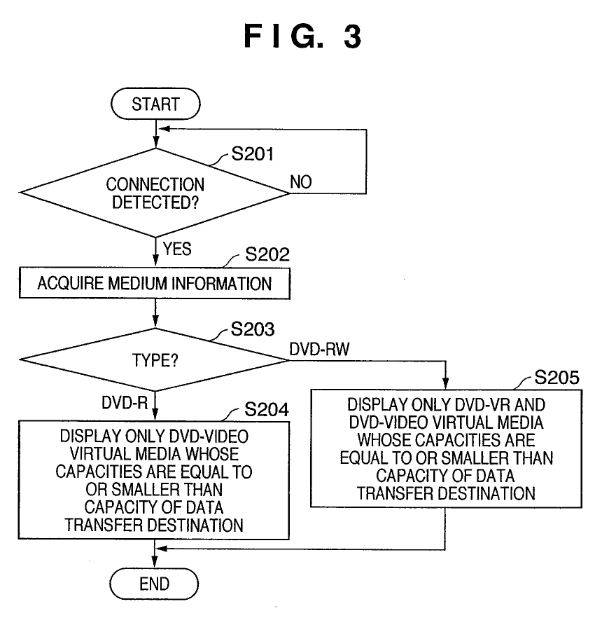

A sequence to detect connection will be explained with reference to FIG. 3. FIG. 3 is a flowchart showing the sequence of processing to detect connection of the DVD external storage apparatus B0 by the video camcorder A0.

In step S201, the interface controller A3 of the video camcorder A0 transmits a detection instruction to the DVD external storage apparatus B0 via the communication cable C0 to detect the external storage medium D0.

If the interface controller A3 of the video camcorder A0 receives medium information as a response to the detection instruction from the DVD external storage apparatus B0 via the communication cable C0, it determines that it has detected that the external storage medium D0 has been connected accessibly. In this case, the interface controller A3 advances the process to step S202. If the interface controller A3 does not receive medium information, it determines that it has not detected that the external storage medium D0 has been connected accessibly. Then, the process returns to step S201.

The medium information includes information on the type of external storage medium D0, the storage capacity of the external storage medium D0, and the recordable format of the external storage medium D0.

In step S202, the microcomputer A8 acquires the medium information from the interface controller A3.

In step S203, the microcomputer A8 determines based on the medium information whether the type of external storage medium D0 is a DVD-R or DVD-RW. If the microcomputer A8 determines that the type is a DVD-R, the process advances to step S204; if it determines that the type is a DVD-RW, to step S205.

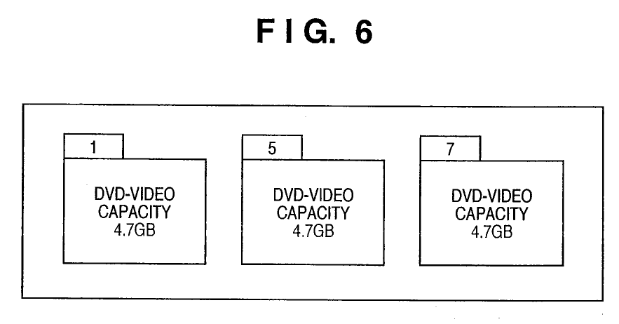

In step S204, the microcomputer A8 acquires management information from the file controller A9. Based on the medium information and management information, the microcomputer A8 determines virtual medium regions proper for the external storage medium type “DVD-R”. The microcomputer A8 generates virtual medium selection window data as a set of only pieces of information on the proper virtual medium regions, and supplies it to the display control processor A6. The display control processor A6 displays a virtual medium selection window (see FIG. 6) on the display panel A7 based on the virtual medium selection window data.

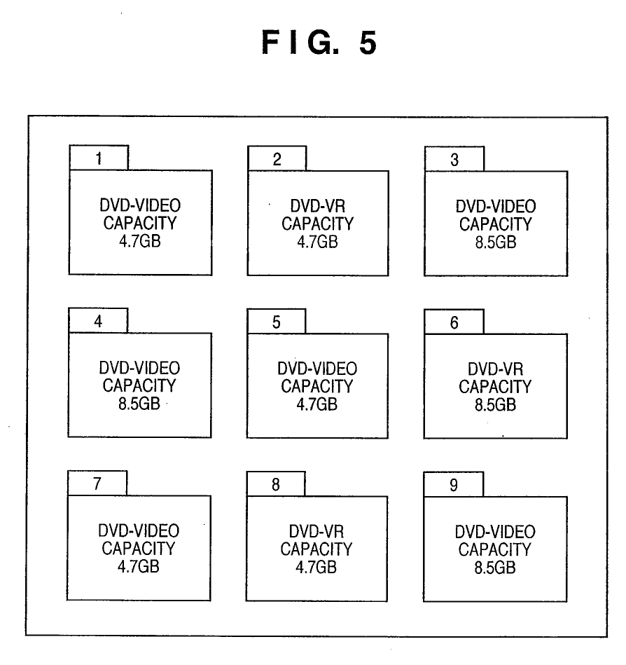

For example, based on the medium information, the microcomputer A8 determines that the external storage medium D0 is a DVD-R having a storage capacity of 4.7 GB. Based on the management information, the microcomputer A8 determines that all the virtual medium regions contained in the internal storage medium A10 are “1” to “9” shown in FIG. 5. The microcomputer A8 selects, from the virtual medium regions “1” to “9”, regions having a storage capacity of 4.7 GB or less and the storage format “DVD-VIDEO” corresponding to “DVD-R”. The microcomputer A8 determines that the virtual medium regions “1”, “5”, and “7” are proper. The microcomputer A8 generates virtual medium selection window data as a set of only pieces of information on the virtual medium regions “1”, “5”, and “7”, and supplies it to the display control processor A6. The display control processor A6 displays the virtual medium selection window shown in FIG. 6 on the display panel A7 based on the virtual medium selection window data. That is, based on the determination result of the microcomputer A8, the display control processor A6 displays a window for selecting a proper virtual medium region.

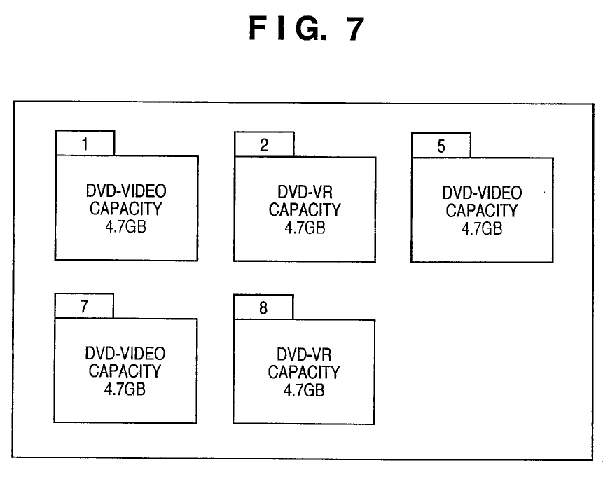

In step S205, the microcomputer A8 acquires management information from the file controller A9. Based on the medium information and management information, the microcomputer A8 determines virtual medium regions proper for the external storage medium type “DVD-RW”. The microcomputer A8 generates virtual medium selection window data as a set of only pieces of information on the proper virtual medium regions, and supplies it to the display control processor A6. The display control processor A6 displays a virtual medium selection window (see FIG. 7) on the display panel A7 based on the virtual medium selection window data.

For example, based on the medium information, the microcomputer A8 determines that the external storage medium D0 is a DVD-RW having a storage capacity of 4.7 GB. Based on the management information, the microcomputer A8 determines that all the virtual medium regions contained in the internal storage medium A10 are “1” to “9” shown in FIG. 5. The microcomputer A8 selects, from the virtual medium regions “1” to “9”, regions having a storage capacity of 4.7 GB or less and the file structures “DVD-VIDEO” and “DVD-VR” corresponding to “DVD-RW”. The microcomputer A8 determines that the virtual medium regions “1”, “2”, “5”, “7”, and “8” are proper. The microcomputer A8 selects these regions. The microcomputer A8 generates virtual medium selection window data for the virtual medium regions, and supplies it to the display control processor A6. The display control processor A6 displays the virtual medium selection window shown in FIG. 7 on the display panel A7 based on the virtual medium selection window data. That is, based on the determination result of the microcomputer A8, the display control processor A6 displays a window for selecting a proper virtual medium region.

The user operates the operation switch A11 to select a virtual medium used for dubbing (data transfer) from displayed virtual media. The microcomputer A8 controls the file controller A9 to reproduce data from the virtual medium selected from the internal storage medium A10, and transfer the data to the interface controller A3. The microcomputer A8 transmits a command to the external storage apparatus B0 via the interface controller A3 to store transmitted data. At the same time, the microcomputer A8 transmits the reproduced virtual data.

The external storage apparatus B0 sequentially stores the transmitted data in the external storage medium D0.

In this fashion, the video camcorder A0 can display, on the display panel A7, a virtual medium selection window of only virtual medium regions proper for the relationship with the external storage medium D0 connected via the communication cable C0 and DVD external storage apparatus B0. The user can easily select, from many virtual disk regions of various types, a virtual disk region proper for the relationship with the external storage medium. This can reduce the workload when transferring data to the external storage medium.

It should be noted that, although the first embodiment has exemplified a DVD as a storage medium serving as a dubbing destination (data transfer destination), the present invention is also applicable to an HD-DVD, Blu-ray disk, and the like.

Although the first embodiment has described only MPEG2 as a moving image data coding format, for example, a coding format such as H.264 is also available for a Blu-ray disk. In this case, virtual medium information additionally contains information representing that the storage capacity is 25 GB, the coding format is H.264, and the storage format is BD-Video.

When the user selects a Blu-ray disk as a virtual medium, the microcomputer A8 may select, from the virtual medium regions “1” to “9”, virtual medium regions having a predetermined coding format in addition to a storage capacity of a predetermined value.

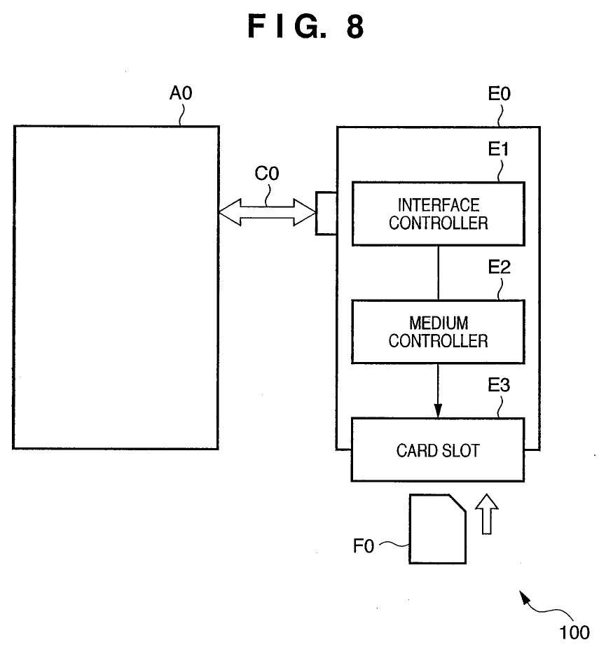

A data transfer system 100 according to the second embodiment of the present invention will be described with reference to FIG. 8. FIG. 8 is a view showing the configuration of the data transfer system 100 according to the second embodiment of the present invention. In FIG. 8, the same part as that in the first embodiment is simply illustrated.

The data transfer system 100 has the same basic configuration as that in the first embodiment except that it comprises a card reader/writer (external storage apparatus) E0.

The card reader/writer E0 is an external card reader, and is connected to a video camcorder A0 via a communication cable C0. The card reader/writer E0 can store information (e.g., video data) received from the video camcorder A0 in an external storage medium F0. Also, the card reader/writer E0 can supply information stored in the external storage medium F0 to the video camcorder A0 to reproduce it. The external storage medium F0 is, for example, a card type high-density storage medium. The type of external storage medium F0 is, for example, an SD card.

As shown in FIG. 8, the card reader/writer E0 comprises an interface controller E1, medium controller E2, and card slot E3.

When the card reader/writer E0 is connected to the video camcorder A0 via the communication cable C0, the interface controller E1 receives a detection signal from the video camcorder A0 via the communication cable C0 to detect the external storage medium F0.

The medium controller E2 receives the detection instruction from the interface controller E1, and reads out medium information from the external storage medium F0 via the card slot E3. The medium controller E2 transfers the medium information to the interface controller E1.

The interface controller E1 transmits, to the video camcorder A0 via the communication cable C0, the medium information received from the medium controller E2.

The external storage medium F0 is detachably inserted into the card slot E3. The card slot E3 is an interface for write/read in/from the external storage medium F0.

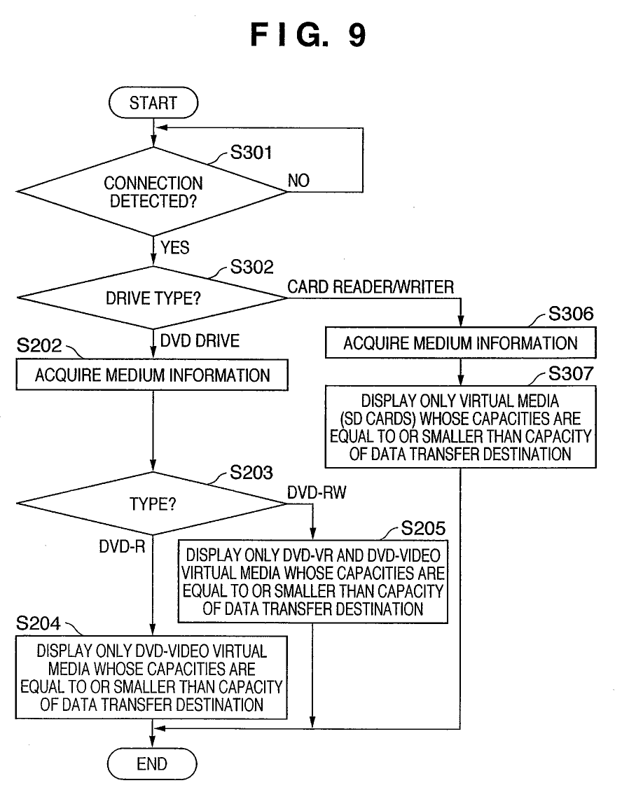

As shown in FIG. 9, a sequence to detect connection is different from that in the first embodiment. FIG. 9 is a flowchart showing the sequence of processing to detect connection of the card reader/writer E0 by the video camcorder A0. Processes different from those shown in FIG. 3 will be mainly described, and a description of the same processes will not be repeated.

In step S301, an interface controller A3 of the video camcorder A0 transmits a detection instruction to the card reader/writer E0 via the communication cable C0 to detect the external storage medium F0.

If the interface controller A3 of the video camcorder A0 receives external storage information and medium information as a response to the detection instruction from the card reader/writer E0 via the communication cable C0, it determines that it has detected connection of the card reader/writer E0. In this case, the interface controller A3 advances the process to step S302. If the interface controller A3 receives neither external storage information nor medium information, it determines that it has not detected connection of the card reader/writer E0. Then, the process advances to step S301.

The external storage information includes information on the type of apparatus (external storage apparatus) which writes/reads out data in/from the external storage medium F0. The medium information includes information on the type of external storage medium F0, the storage capacity of the external storage medium F0, and the recordable format of the external storage medium F0.

In step S302, a microcomputer A8 receives the external storage information from the interface controller A3. Based on the external storage information, the microcomputer A8 determines whether the external storage apparatus is a DVD external storage apparatus or card reader/writer. If the microcomputer A8 determines that the external storage apparatus is a DVD external storage apparatus, the process advances to step S202. If the microcomputer A8 determines that the external storage apparatus is a card reader/writer, the process advances to step S306.

In step S306, the microcomputer A8 acquires the medium information from the interface controller A3. The medium information includes information on the type of external storage medium F0, the storage capacity of the external storage medium F0, and the recordable format of the external storage medium F0.

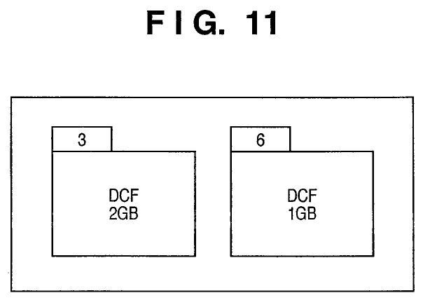

In step S307, the microcomputer A8 acquires management information from a file controller A9. Based on the medium information and management information, the microcomputer A8 determines virtual medium regions proper for the external storage medium type “SD card”. The microcomputer A8 generates virtual medium selection window data for only the proper virtual medium regions, and supplies it to a display control processor A6. The display control processor A6 displays a virtual medium selection window (see FIG. 11) on a display panel A7 based on the virtual medium selection window data.

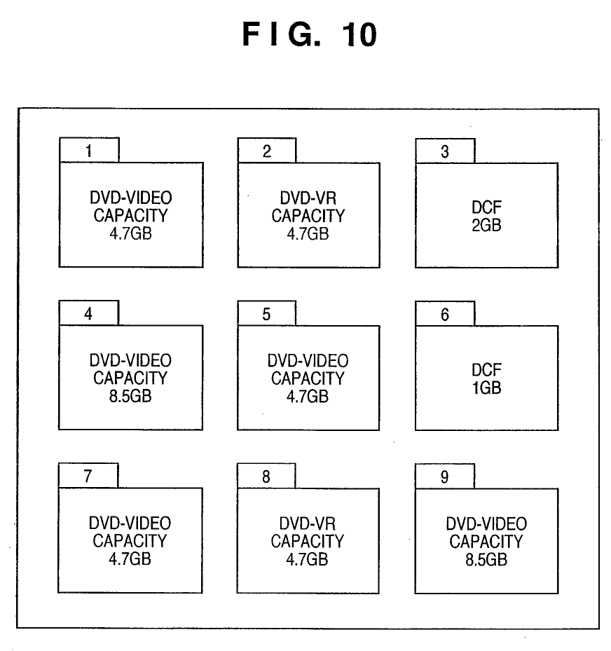

For example, based on the medium information, the microcomputer A8 determines that the external storage medium F0 is an SD card having a storage capacity of 2 GB. Based on the management information, the microcomputer A8 determines that all the virtual medium regions contained in an internal storage medium A10 are “1” to “9” shown in FIG. 10. The microcomputer A8 selects, from the virtual medium regions “1” to “9”, regions having a storage capacity of 2 GB or less and the file structure “DCF” corresponding to “SD card”. The microcomputer A8 determines that the virtual medium regions “3” and “6” are proper. The microcomputer A8 generates virtual medium selection window data for the virtual medium regions “3” and “6”, and supplies it to the display control processor A6. The display control processor A6 displays the virtual medium selection window shown in FIG. 11 on the display panel A7 on the basis of the virtual medium selection window data. That is, based on the determination result of the microcomputer A8, the display control processor A6 displays a window for selecting a proper virtual medium region.

As described above, the video camcorder A0 specifies virtual medium regions proper for the relationship with the external storage medium D0 or F0 connected via the communication cable C0 and an external storage apparatus (a DVD external storage apparatus B0 or the card reader/writer E0). The video camcorder A0 can display, on the display panel A7, a virtual medium selection window of only the proper virtual medium regions. The user can easily select, from many virtual disk regions of various types, a virtual disk region proper for the relationship with the external storage apparatus and external storage medium. This can reduce the workload when transferring data to the external storage medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-303381, filed Nov. 8, 2006 which is hereby incorporated by reference herein in its entirety.

What is claimed is:

1. A reproduction apparatus comprising:
a reproduction unit which reproduces information data stored in a storage medium;
a management unit which manages pieces of information data stored in the storage medium by classifying the pieces of information data into a plurality of groups corresponding to types of external storage media for storing information data reproduced from the storage medium;
a communication unit which communicates with an external storage apparatus that stores information data in the external storage medium, and which receives medium information relating to a type of external storage medium from the external storage apparatus;
a search unit which searches the plurality of groups for a group corresponding to the type of external storage medium based on the medium information received by the communication unit; and
a display control unit which displays, on a display unit, information on the group detected by the search unit.

2. The apparatus according to claim 1, further comprising:
a selection unit which accepts an instruction to select a group from at least one group detected by the search unit by using the information on the group that is displayed on the display unit by the display control unit;
a control unit which controls the reproduction unit so as to reproduce, from the storage medium, information data of the group designated by the instruction accepted by the selection unit; and
an output unit which outputs the information data reproduced from the storage medium to the external storage apparatus so as to store the information data in the external storage medium.

3. The apparatus according to claim 1, wherein the management unit generates the group in accordance with at least one of a storage capacity of the external storage medium, a coding format of information data recordable in the external storage medium, and a recordable format of the external storage medium.

4. The apparatus according to claim 1, wherein
the communication unit further receives external storage information serving as information on the external storage apparatus from the external storage apparatus and
the search unit searches the plurality of groups for a group corresponding to the type of external storage medium and a type of external storage apparatus based on the external storage information and the medium information.

5. The apparatus according to claim 4, wherein
the external storage information includes information on the type of external storage apparatus.

6. The apparatus according to claim 1, further comprising:
an input unit which receives an instruction to select the type of external storage medium compliant with the medium information; and
a storage unit which stores the information data in the storage medium,
wherein the management unit generates the group in accordance with the type of external storage medium designated by the instruction input to the input unit.

7. A data transfer system comprising:
a detachable external storage apparatus;
a reproduction apparatus defined in claim 1; and
a communication medium which connects the external storage apparatus to the reproduction apparatus.
